(19) United States
(12) Patent Application Publication
(10) Pub. No.: US 2008/0140268 A1
(43) Pub. Date: Jun. 12, 2008

(54) Total engine smart indicator for an aircraft, and application thereof

(75) Inventor: Luigi Todini, Fort Worth, TX (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Howell Instruments, Inc., Fort Worth, TX (US)

(21) Appl. No.: 11/636,459

(22) Filed: Dec. 11, 2006

(51) Int. Cl. G06F 19/00

(52) U.S. Cl. 701/3; 701/1

(57) ABSTRACT

A smart indicator for an engine, and applications thereof. In an embodiment, the indicator includes a processing module and a display. The processing module receives a plurality of input parameter signals from various engine sensors. The input parameter signals are transformed by the processing module into values that can be displayed on the display. The display depicts at least the most relevant transformed value for controlling the engine and how this transformed value relates to an associated limit value for the engine such as, for example, a temperature limit value, a rotational speed limit value, or a torque limit value. In one embodiment, the input parameter signals are transformed by converting the input parameter signals to a plurality of digital values, subtracting an appropriate limit value for the engine from each digital value, dividing each resulting difference value by the appropriate limit value for the engine, and multiplying the resulting quotient value by a scaling value.

### FIELD OF THE INVENTION

The present invention relates to engine instrumentation. More particularly, it relates to aircraft engine instrumentation.

### BACKGROUND OF THE INVENTION

The performance and capabilities of an aircraft are dependent on the performance and capabilities of its engine(s). Thus, it is vitally important that aircrew members evaluate engine performance and capabilities during flight operations in order to ensure continued safe operation of the aircraft.

Conventional engine instrumentation for an aircraft requires aircrew members to scan and monitor multiple indicators for each engine to verify that the engines are not exceeding a limit value that will effect continued safe operation of the aircraft. This task is particularly challenging when, for example, during flight operations an aircrew is directed to change its mission. A change in mission during flight operations requires aircrew members to re-evaluate the performance and capabilities of the aircraft in real time while concurrently trying to navigate and operate the aircraft. This leads to increased cockpit workload and aircrew stress and may result in evaluation errors that can cause the aircrew to operate the aircraft in an unsafe manner. Such errors are particularly critical when evaluating a rotary wing aircraft's performance and capabilities and can quickly lead to the loss of the aircraft and the aircrew.

What is presently needed is aircraft engine instrumentation that permits aircrew members to quickly determine the performance and capabilities of an engine during flight operations.

### BRIEF SUMMARY OF THE INVENTION

The present invention provides a smart indicator for an engine, and applications thereof. In an embodiment of the present invention, the indicator includes a processing module and a display. The processing module receives a plurality of input parameter signals from various engine sensors. The input parameter signals are transformed by the processing module into values that can be displayed on the display. The display depicts at least the most relevant transformed value for controlling the engine and how this transformed value relates to an associated limit value for the engine such as, for example, a temperature limit value, a rotational speed limit value, or a torque limit value.

In one embodiment, the input parameter signals are transformed by converting the input parameter signals to a plurality of digital values, subtracting an appropriate limit value for the engine from each digital value, dividing each resulting difference value by the appropriate limit value for the engine, and multiplying the resulting quotient value by a scaling value.

In an embodiment, the display of the indicator can be changed to show the untransformed input parameter signals such as, for example, turbine gas temperature, compressor rotational speed, and/or torque. This functionality allows the indicator to be used either as primary instrumentation, capable of displaying all engine parameters, or as a stand-by indicator in applications where such instrumentation is preferable or required.

In an embodiment, where the indicator is installed in a cockpit of an aircraft, the indicator display automatically switches from one configuration to another configuration according to the type of engine being monitored and a particular phase of flight of the aircraft such as, for example, engine start-up, engine idle, aircraft take-off, aircraft cruse, and aircraft landing. It is a feature of the present invention that it enhances aircrew situational awareness and flight safety while reducing aircrew cockpit workload.

Further features and advantages of the present invention, as well as the structure and operation of various embodiments of the present invention, are described in detail below with reference to the accompanying drawings.

### BRIEF DESCRIPTION OF THE DRAWINGS/FIGURES

The present invention is described with reference to the accompanying figures. In the figures, like reference numbers indicate identical or functionally similar elements. Additionally, the left-most digit or digits of a reference number identify the figure in which the reference number first appears. The accompanying figures, which are incorporated herein and form part of the specification, illustrate the present invention and, together with the description, further serve to explain the principles of the invention and to enable persons skilled in the relevant art(s) to make and use the invention.

FIG. 1 is a diagram of an example aircraft in which the present invention may be used.

FIG. 2 is a diagram illustrating an example engine whose performance and capabilities may be monitored and displayed using the present invention.

FIG. 3 is a diagram of an engine indicator according to an embodiment of the present invention.

FIG. 4 is a diagram of an example processing module for an engine indicator according to an embodiment of the present invention.

FIG. 5A is a diagram of an example engine indicator display according to an embodiment of the present invention.

FIG. 5B is a diagram of an example engine indicator display according to an embodiment of the present invention.

FIG. 6A is a diagram of an example engine indicator display according to an embodiment of the present invention.

FIG. 6B is a diagram of an example engine indicator display according to an embodiment of the present invention.

FIG. 6C is a diagram of an example engine indicator display according to an embodiment of the present invention.

FIG. 7 is a diagram of an example engine indicator display according to an embodiment of the present invention.

FIG. 8 is a diagram of an example engine indicator display according to an embodiment of the present invention.

FIG. 9 is a diagram of an example engine indicator display according to an embodiment of the present invention.

### DETAILED DESCRIPTION OF THE INVENTION

The present invention provides a smart indicator for an engine, and applications thereof. In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled iri the art to affect such feature, structure, or characteristic in connection with other embodiments whether or not explicitly described.

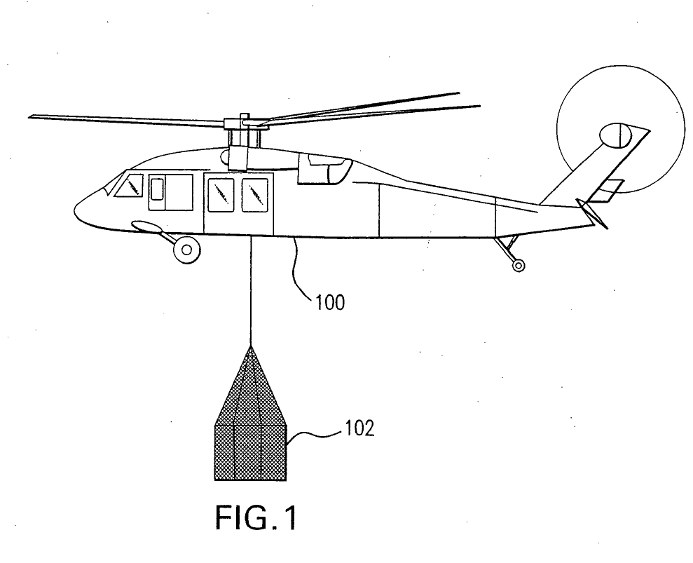

FIG. 1 is a diagram of an example aircraft 100 in which the present invention may be used. Aircraft 100 is a rotary wing aircraft capable of lifting and transporting an external load 102 using a hook (not shown). As would be known to persons skilled in the relevant art(s), before attempting to lift and transport external load 102, an aircrew member of aircraft 100 must verify that lifting and transporting external load 102 is within the capabilities of aircraft 100. If the aircrew members of aircraft 100 attempt to lift and transport an external load 102 that would cause aircraft 100 to exceed its operational capabilities, it is likely that aircraft 100 would fail and could be destroyed, possibly killing all persons aboard aircraft 100.

Whether aircraft 100 can safely lift and transport external load 102 is dependent on the performance and capabilities of the engines of aircraft 100. As described below, using an embodiment of the present invention, the aircrew members of aircraft 100 are able to quickly, easily, and accurately evaluate engine performance and capabilities prior to and during the lifting of external load 102. They also are able to continually monitor the engines of aircraft 100 and verify the engines are not exceeding a limit value that would effect the continued safe operation of aircraft 100 while transporting external load 102 to its destination. If at any time during the lifting and transporting of external load 102 conditions should change such that a limit value of an engine is met or exceeded, the present invention will alert the aircrew members of aircraft 100 of the change, thereby allowing the aircrew members to take immediate corrective action.

The importance of an aircrew member being able to quickly, easily, and accurately evaluate engine performance and capabilities is not limited to just the situation describe above for aircraft 100. The example of aircraft 100 lifting and transporting an external load 102 is intended only to illustrate one situation in which the utility of the present invention will be apparent to persons skilled in the relevant art(s). As would be known to persons skilled in the relevant art(s), the importance of aircrew members being able to quickly, easily, and accurately evaluate engine performance and capabilities is equally applicable to all types of aircraft, including fixed wing aircraft, during all phases of flight. The present invention also has utility in non-aviation applications such as, for example, the monitoring of gas turbine engines used to generate electricity.

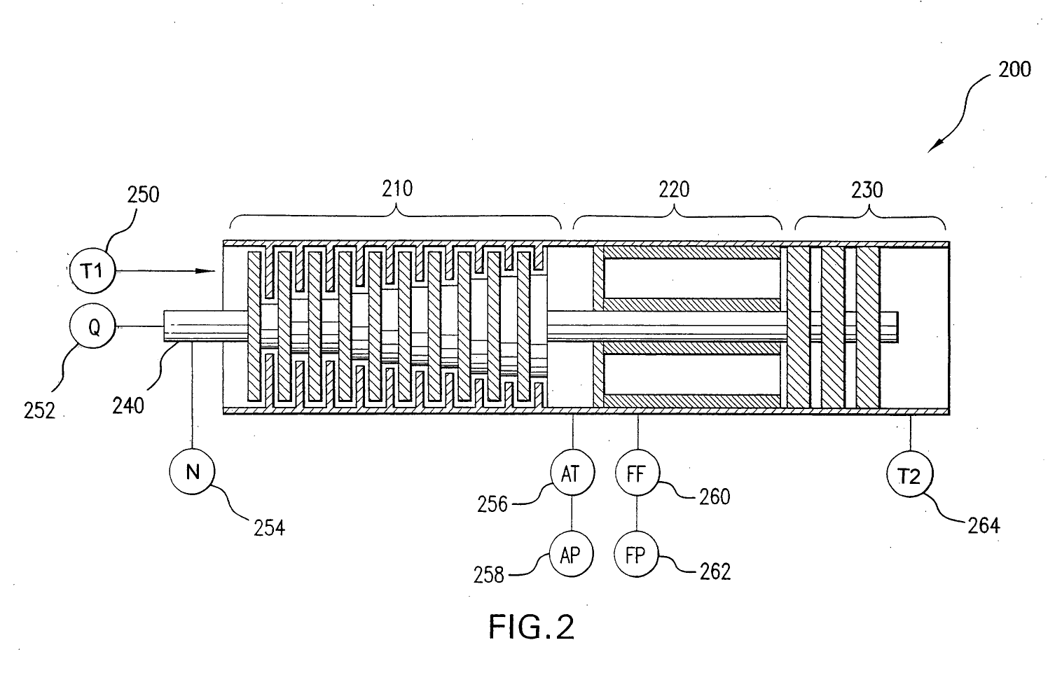

FIG. 2 is a diagram of an example aircraft engine 200, whose performance and capabilities can be monitored and evaluated using the present invention. Aircraft engine 200 is a turboshaft engine similar in type to that used by rotary wing aircraft 100. As will become apparent based on the description herein, the present invention also can be used equally well to monitor and evaluate other types of engines.

Engine 200 comprises a compressor or compressor stage 210, a combustor or combustion stage 220, and a turbine or turbine stage 230. A shaft 240 couples the compressor 210 to the turbine 230 and transfers power from engine 200 to the main and tail rotors of aircraft 100. Engine 200 is a conventional aircraft engine, which would be well known to persons skilled in the relevant art(s).

As illustrated in FIG. 2 and described herein, there are several engine performance related parameters that can be sensed and used to monitor and evaluate the performance and capabilities of engine 200. These parameters include engine intake or ambient air temperature 250, the torque 252 of shaft 240, the rotational speed 254 of shaft 240, the discharge air temperature 256 of compressor 210, the discharge air pressure 258 of compressor 210, the fuel flow 260 to combustor 220, the fuel pressure 262 used to deliver fuel to combustor 220, and the exhaust gas temperature 264 of turbine 230.

In embodiments of the present invention, one or more of the above noted engine performance related parameters are sensed and converted to electrical signals, for example, using available aircraft instrumentation sensors. For example, conventional thermocouples can be used to sense engine intake temperature 250, the discharge air temperature 256 of compressor 210, and the exhaust gas temperature 264 of turbine 230. The output of an electrical generator, coils and/or magnetic switches coupled to shaft 240 can be used to sense the rotational speed 254 of shaft 240, and convert it into an electrical signal. Similarly, conventional pressure gauges can be used to sense the discharge air pressure 258 of compressor 210 and the fuel flow 260 to combustor 220 and convert these engine performance related parameters to electrical signals.

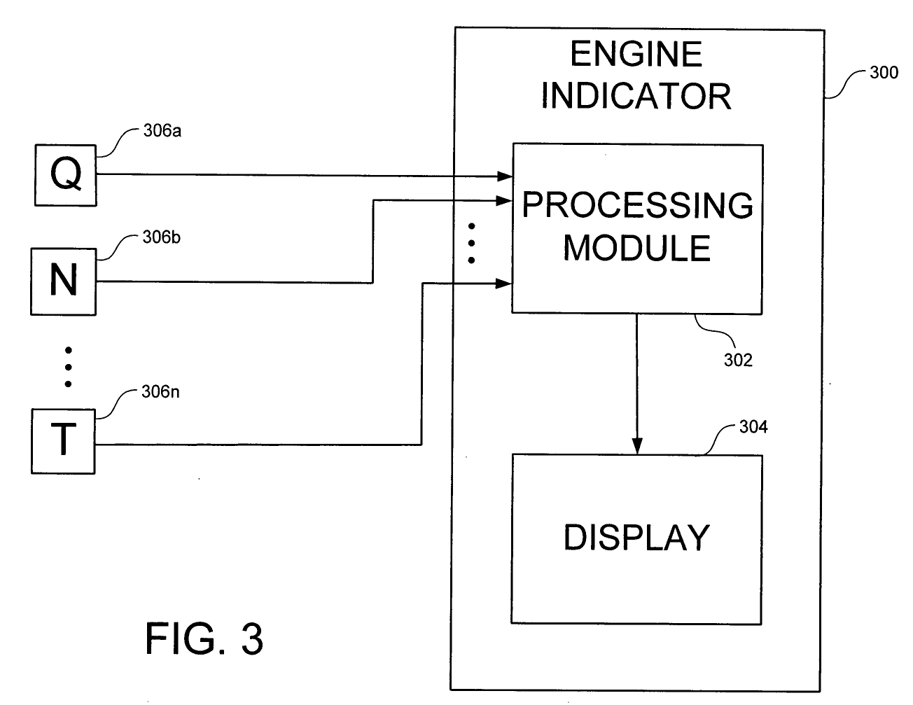

FIG. 3 is a block diagram of an indicator 300 according to an embodiment of the present invention. Indicator 300 includes a processing module 302 and a display 304. In an embodiment, display 304 is an active matrix display. As shown in FIG. 3, processing module 302 of indicator 300 receives input signals from a plurality of sensors 306a-n. Sensors 306 are used to monitor, for example, some or all of the engine parameters shown in FIG. 2. In embodiments, the input signals received by indicator 300 are associated with more than one engine, thereby allowing indicator 300 to operate in a multi-engine display mode.

In an embodiment of the present invention, sensors 306 output analog signals representative of engine parameters such as temperature, torque and rotational speed. Sensors 306 can be shared engine instrumentation sensors or dedicated sensors, whose output signals are provided only to indicator 300. Processing module 302 receives the analog signals output by sensors 306 and transforms these signals into values that can be displayed on display 304. As described in more detail below, in one instance, the analog signals are converted to digital signals and transformed using a microprocessor into display values that indicate how close a monitored engine is being operated to a limit value for the engine.

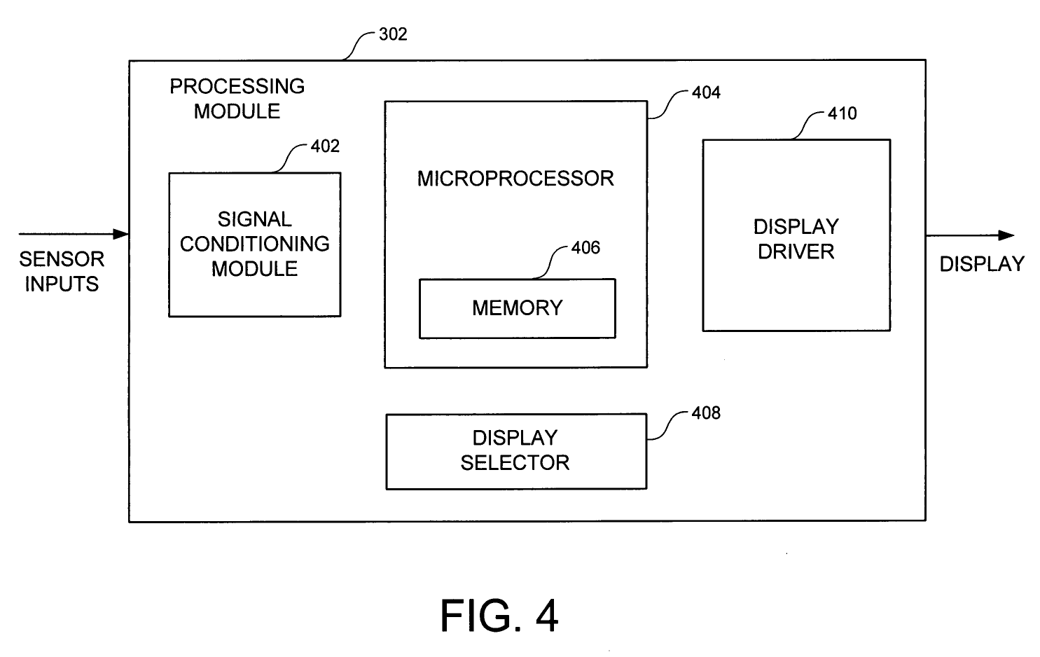

FIG. 4 is a more detailed diagram of processing module 302 according to an embodiment of the present invention. As shown in FIG. 4, in an embodiment processing module 302 includes a signal conditioning module 402, a microprocessor 404 having a memory 406, a display selector 408, and a display driver 410.

Signal conditioning module 402 receives the input signals from sensors 306 and converts these signals to signals that can be operated upon by microprocessor 404. Signal conditioning module 402, for example, buffers and/or amplifies analog signals received from each sensor 306 and converts these analog signals into streams of digital data values representative of the analog signals. These streams of digital data values are stored in one or more buffers until they can be processed by microprocessor 404 and transformed into display values. In one embodiment, in which processing module 302 is implemented using a microcontroller that includes an analog-to-digital converter, signal conditioning module 402 provides analog signals to the microcontroller, and the microcontroller converts the signals into digital data values.

Microprocessor 404 receives digital data values from signal conditioning module 402 and transforms the values into display values. Microprocessor 404 operates under the control of software stored in memory 406. In one embodiment, microprocessor 404 transforms the digital data values into normalized percent difference (A %) values in accordance with equation 1 (EQ. 1) shown below. These normalized values each relate to a particular limit value for a monitored engine such as, for example, a temperature operating limit value, a compressor or turbine rotational speed operating limit value, or a torque operating limit value.

Δ%=((Input Value−Limit Value)/Limit Value)×100 EQ. 1

Display selector 408 is used to select between a variety of possible displays or display modes. In an embodiment, these displays include a primary display that displays, for example, one or more normalized percent difference values and a plurality of secondary displays that display, for example, one or more engine parameter values such as turbine gas temperature, turbine or compressor rotational speed, and engine torque. In an embodiment, in which indicator 300 is used to monitor more than one engine, the various displays can be configured to show data for multiple engines at the same time (multi-engine display mode).

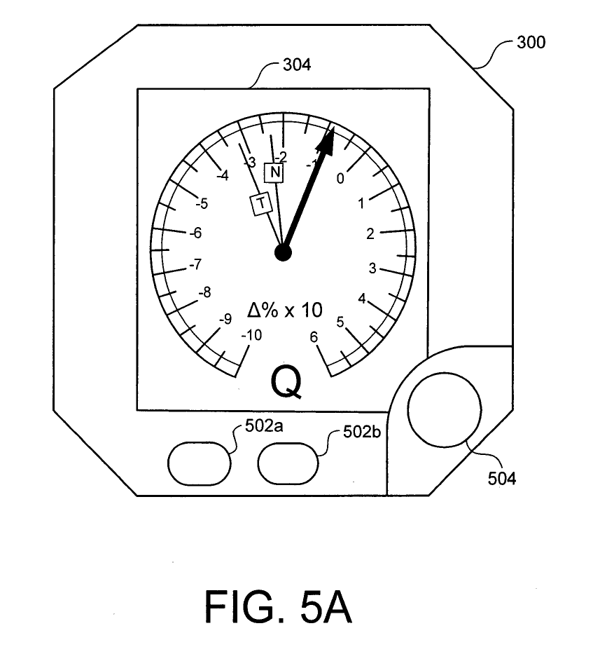

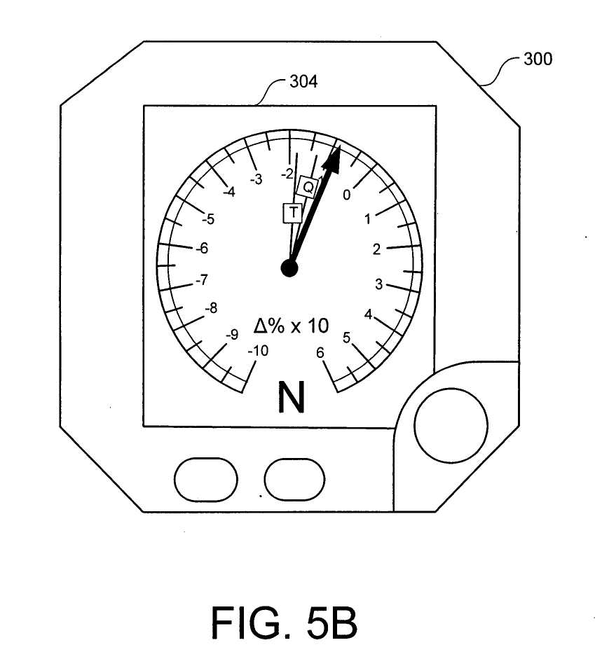

In an embodiment, one or more manual input buttons and/or rotational switches (see, e.g., FIG. 5A) are used to provide an input to display selector 408 and thereby change the data/information that is displayed on display 304. The displays can also be automatically switched in one embodiment in accordance with software residing in memory 406 of microprocessor 404.

In an embodiment in which indicator 300 is used in an aircraft, the displays are automatically switched, for example, according to engine type and aircraft flight regime/phase of flight specifications provided by the engine and aircraft manufacturer(s) and/or customer requests. The automatic switching of the displays can be controlled, for example, using input signals provided to processing module 302, and it can be based on the occurrence of multiple events. In this embodiment, displays which are automatically switched can include an engine starting display mode, an aircraft take-off display mode, an aircraft hover display mode, an aircraft cruse display mode, an inoperative engine display mode, et cetera. Signals other than engine parameter signals can be provided to indicator 300 and used as a basis for switching displays.

Display driver 410 converts display information into signals that are compatible with display 304. Display driver 410 updates display 304 based on information received from microprocessor 404.

In order to more fully appreciate the features and advantages of the present invention, consider a case in which indicator 300 is installed in a helicopter having a turbine engine. The turbine engine has a torque operating limit of 100% torque, a compressor rotational speed operating limit of 105% RPM, and a turbine exhaust gas temperature operating limit of 843° C. During a certain phase of flight, the engine parameter values corresponding to these limit values are determined to be 91.0% torque, 80.8% RPM, and 573° C. These values are summarized below in Table 1.

As described herein, the engine parameter values are provided to processing module 302 of indicator 300, where the parameters are transformed into display values. In one embodiment, the engine values are transformed by converting the engine values into streams of digital values, subtracting the appropriate limit value from each digital value, and dividing each resulting difference value by the appropriate limit value. These normalized display values may also be multiplied by a scaling factor such as, for example, 100 to form percent difference values (Δ%). These values have been calculated and are shown in Table 1.

TABLE 1

| | | | PERCENT |
|---|---|---|---|
| ENGINE | ENGINE | LIMIT | DIFFERENCE |
| PARAMETER | VALUE | VALUE | VALUE |
| Q (%) | 91.0 | 100.0 | −9% |
| N (%) | 80.8 | 105.0 | −23% |
| T (° C.) | 573 | 843 | −32% |

In an embodiment, each normalized display value calculated for a monitored engine is displayed on display 304 of indicator 300. This is shown, for example, in FIG. 5A.

FIG. 5A illustrates an instance in which indicator 300 is being used to display percent difference values for three engine parameters. These parameters are torque (Q), compressor rotational speed (N), and turbine exhaust gas temperature (T). The percent difference values being displayed in FIG. 5A are the percent difference values from Table 1.

In FIG. 5A, the percent difference value for engine torque is indicated by the arrow or primary needle indicator. This is due to the fact that engine torque is the most relevant parameter for controlling the monitored engine because engine torque is closest to its limit value. The percent difference value for torque is also the largest percent difference value. The “Q” at the bottom of display 304 means that the arrow or primary needle indicator represents torque. Two smaller needle indicators show the percent difference values for compressor rotational speed and turbine exhaust gas temperature. The needles are identified by information (e.g., “N” and “T”) to identify which needle represents compressor rotational speed and which needle represents turbine exhaust gas temperature. Although not shown, the scale of display 304 may be marked with green, yellow and red operating ticks and/or arcs, as is customary for instrumentation in the aircraft industry.

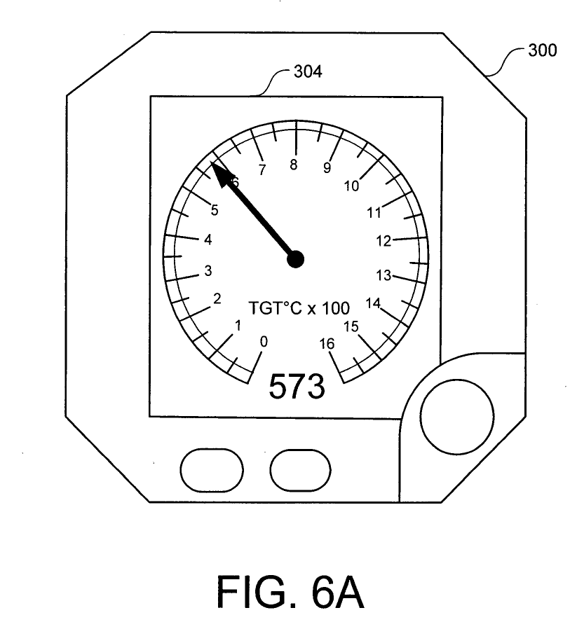

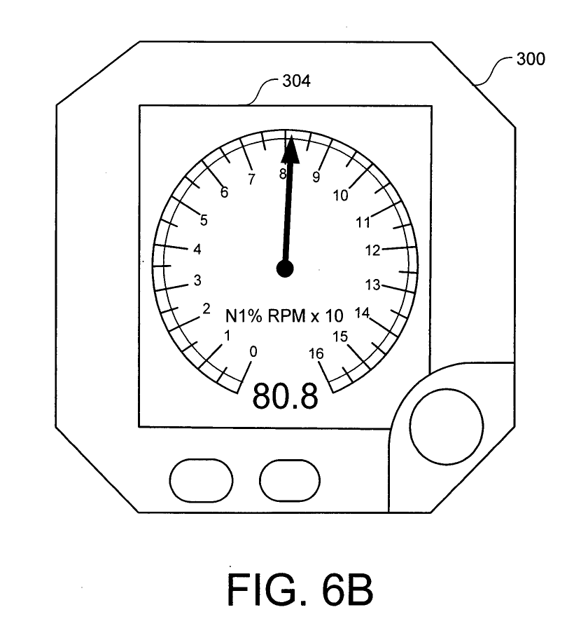

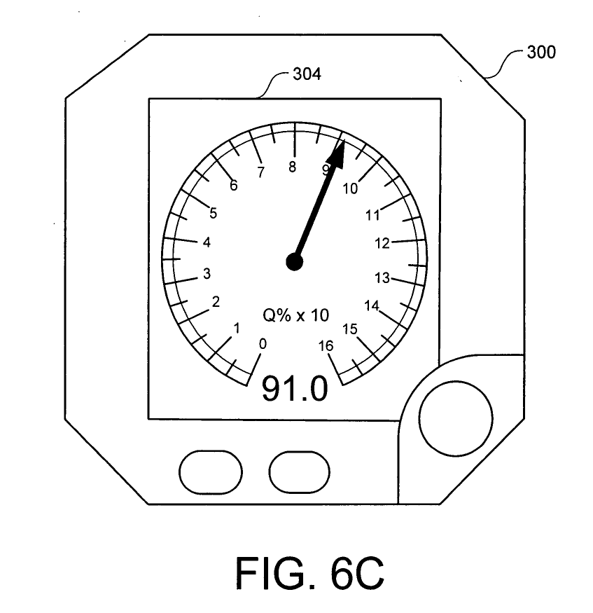

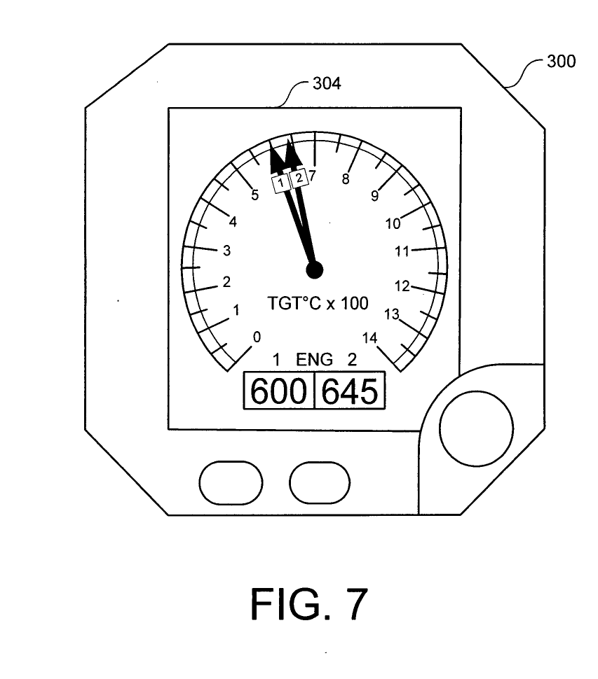

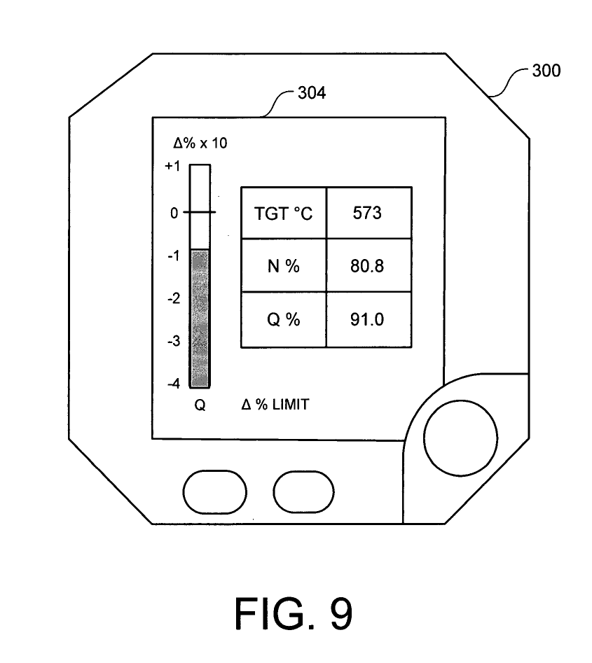

In an embodiment, as shown in FIG. 5A, indicator 300 has one or more buttons 502 and/or a rotary switch 504 that can be used to manually change the information that is displayed on display 304. For example, in one embodiment, turning rotary switch 504 cycles through various secondary displays that show the current value of the turbine exhaust gas temperature (see FIG. 6A), the current value of the compressor rotational speed (see FIG. 6B), and the current value of engine torque (see FIG. 6C) that correspond to the percent difference values shown in FIG. 5A. Other displays are also possible. For example, pushing one of the buttons 502 can change the display from single engine display mode to multi-engine display mode (see FIG. 7). In one embodiment, a button 502 can also be used to change the format and/or information displayed on display 304, for example, from the format and information shown in FIG. 5A to the format and information shown in FIG. 9.

In an embodiment of the present invention, the information that is displayed by indicator 300, and the format used to display the information, is programmable. For example, a display can have one or more needles, needles of various shapes and sizes, scales of different sizes and ranges, indicating bars and/or digital information. Thus, the information that is displayed by indicator 300, as well as the various displays that are available for selection, can be tailored to meet customer specifications and desires. Accordingly, the present invention is not to be limited to the example displays presented herein.

FIG. 5B illustrates an example display, similar to FIG. 5A, in which indicator 300 is being used to display percent difference values for engine torque (Q), compressor rotational speed (N), and turbine exhaust gas temperature (T). In FIG. 5B, however, the percent difference value for compressor rotational speed is indicated by the arrow or primary needle indicator. This is indicated by the “N” at the bottom of display 304. The arrow or primary needle indicator represents compressor rotational speed because, for the particular phase of flight represented in FIG. 5B, compressor rotational speed (rather than engine torque as is the case in FIG. 5A) is the most relevant parameter for controlling the monitored engine. Compressor rotational speed is closer to its limit value than are engine torque and turbine exhaust gas temperature. In embodiments of the present invention, the primary needle always displays the engine parameter that is closest to an engine operating limit value. In addition, although not shown in FIG. 5B, the scale of display 304 may be marked with green, yellow and red operating ticks and/or arcs.

As will be understood by persons skilled in the relevant art(s), for flying purposes, only the primary needles shown in FIGS. 5A and 5B are necessary for safe operation of an aircraft. This is due to the fact that upon reaching a limit value for any engine parameter, a pilot is trained to reduce engine power in order to return the engine to a normal operating range. Thus, in one embodiment of the present invention, indicator 300 only displays the percent difference value having the highest value as this is the most relevant information for continued safe operation of the aircraft. In such an embodiment, for an aircraft having more than one engine, multiple needles can be used to display the engine parameter for each engine that is closest to an engine operating limit value.

As described herein, indicator 300 can be used either as the engine primary instrumentation for an aircraft or as a stand-by indicator. As described above, in one embodiment, turning rotary switch 504 cycles through various secondary displays that show the current values of engine parameters. For example, FIG. 6A shows indicator 300 being used to display turbine exhaust gas temperature. FIG. 6B shows indicator 300 being used to display compressor rotational speed. FIG. 6C shows indicator 300 being used to display engine torque. Other displays (not shown) include, for example, a display for engine intake air temperature, a display for compressor discharge air temperature, a display for compressor discharge air pressure, a display for fuel flow, and a display for fuel pressure. Other possible displays will become apparent to persons skilled in the relevant art(s) given the description herein.

FIG. 7 shows an example display in which indicator 300 is operating in multi-engine display mode. In FIG. 7, display 304 includes two needles that indicate turbine exhaust gas temperature. Needle 1 shows the turbine exhaust gas temperature for engine number 1 (600° C.). Needle 2 shows the turbine exhaust gas temperature for engine number 2 (645° C.). This information is also optionally included in digital format below the analog scale. Embodiments of the present invention include similar displays for other engine parameters when indicator 300 is used to monitor more than one engine.

As described above, in an embodiment, the displays of indicator 300 are automatically switched, for example, according to engine type and aircraft flight regime/phase of flight specifications provided by the engine and aircraft manufacturer(s) and/or customer requests. The automatic switching of the displays can be controlled, for example, using input signals provided to processing module 302, and it can be based on the occurrence of multiple events.

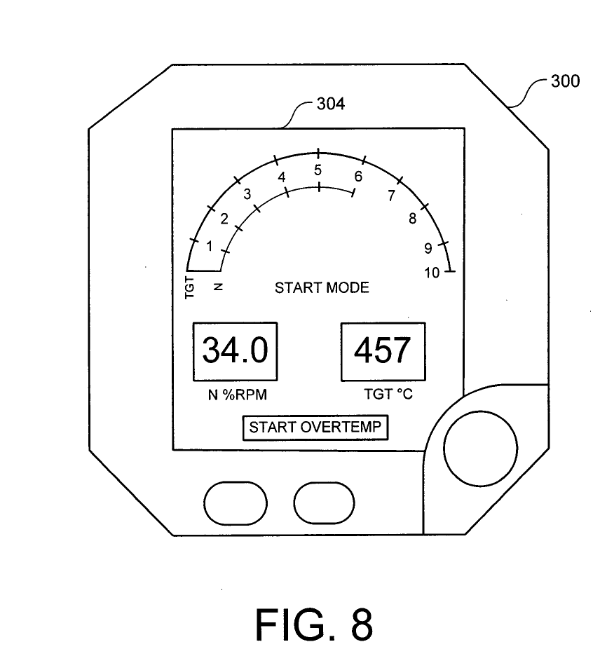

FIG. 8 illustrates an example display 304 for an engine start display mode. As shown in FIG. 8, in engine start display mode, display 304 depicts values for both turbine exhaust gas temperature and compressor rotational speed. These values are optionally presented in both an analog and a digital format. In embodiments, display 304 also presents alarms such as, for example, a start over-temperature alarm when such an alarm condition exists. When the engine is stable, for example, at ground idle, the display of indicator 300 automatically switches to another display. Other display switches may occur, for example, when compressor rotational speed exceeds ground idle (e.g., the display will change to a running display mode), when both compressor rotational speed exceeds a selected value and engine torque exceeds a selected value for more than a selected number of seconds (e.g., the display will change to a take-off display mode) and/or when both compressor rotational speed is less than a selected value and engine torque is less than a selected value for more than a selected number of seconds (e.g., the display will change to an inoperative engine display mode). Other display modes are contemplated and will become apparent to persons skilled in the relevant art(s) given the description herein. Thus, the present invention is not limited to only the example display modes described herein.

FIG. 9 illustrates a display 304 that can be used, for example, as an engine primary instrumentation display. The display in FIG. 9 depicts several monitored parameters for an engine and a bar that indicates which monitored parameter is closest to its limit value.

Based on the description herein, it will become apparent to persons skilled in the relevant art(s) that the present invention is a total engine, smart indicator. This smart indicator can be used to monitor and evaluate aircraft engine performance and capabilities by aircrews during flight operations. The indicator also can store engine parameter data such as, for example, peaks and cycles during flight operations, which can be retrieved and used by maintenance personnel.

Although the present invention has been described herein using examples primarily related to aviation, the present invention can be used to monitor and evaluate engines other than those installed in an aircraft such as, for example, gas turbines used to generate electricity. The example embodiments described herein have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. An indicator for an engine, comprising:
a processing module that receives a plurality of signals related to an engine and transforms the signals into a plurality of normalized values, each normalized value relating to an operating limit for the engine; and
a display, coupled to the processing module, that displays the normalized value having the greatest value.

2. The indicator of claim 1, wherein the display displays information that identifies the operating limit associated with the displayed normalized value.

3. The indicator of claim 1, wherein the display displays at least two normalized values and information that identifies the operating limits associated with the at least two normalized values.

4. The indicator of claim 1, wherein the displayed normalized value is formed by subtracting a limit value for the engine from a valued formed from a first received signal and dividing the resulting difference value by the limit value for the engine.

5. The indicator of claim 1, wherein the displayed normalized operating value is formed by subtracting a limit value for the engine from a valued formed from a first received signal, dividing the resulting difference value by the limit value for the engine, and multiplying the resulting quotient value by a scaling value.

6. The indicator of claim 1, wherein the engine is a turbine engine and the displayed normalized value is associated with one of a temperature operating limit, a rotational speed operating limit, and a torque operating limit.

7. The indicator of claim 1, wherein the display includes a display selector that changes the information that is displayed.

8. The indicator of claim 7, wherein the engine is a turbine engine and the information that is displayed includes one of a temperature value, a rotational speed value, and a torque value.

9. The indicator of claim 7, wherein the indicator displays information for more than one engine.

10. The indicator of claim 7, wherein the indicator is configured to automatically switch the information that is displayed based on signals received by the processing module.

11. The indicator of claim 10, wherein the information that is displayed is related to a particular phase of flight of an aircraft.

12. The indicator of claim 7, wherein the display selector is responsive to an input button.

13. The indicator of claim 7, wherein the display selector is responsive to a rotary switch.

14. An indicator for an engine, comprising:
a processing module that receives a plurality of engine parameter signals and transforms the engine parameter signals into a plurality of normalized values, wherein each normalized value is associated with a limit value for the engine; and
a display, coupled to the processing module, that displays the most relevant normalized value for controlling the engine.

15. The indicator of claim 14, wherein the most relevant normalized value is a value associated with an engine parameter closest to a limit value for the engine.

16. The indicator of claim 14, wherein the engine is a turbine engine and the most relevant normalized value is associated with one of a temperature limit value, a rotational speed limit value, and a torque limit value.

17. The indicator of claim 14, wherein the display includes a display selector that changes the information that is displayed.

18. The indicator of claim 17, wherein the indicator is configured to switch the information that is displayed based on signals received by the processing module.

19. The indicator of claim 18, wherein the information that is displayed is related to a particular phase of flight of an aircraft.

20. A method for generating and displaying engine data, comprising:
(1) acquiring data relating to a plurality of engine limit values;
(2) transforming the data to form a plurality of normalized values associated with the engine limit values; and
(3) displaying the normalized value most relevant for controlling the engine using a programmable display.

21. The method of claim 20, wherein step (3) comprises displaying a normalized value associated with one of a temperature limit value, a rotational speed limit value, and a torque limit value.

22. The method of claim 20, wherein step (3) comprises displaying the normalized value having the highest value.

23. The method of claim 20, wherein step (2) comprises:
(i) subtracting a first limit value for the engine from a first data value acquired in step (1); and
(ii) dividing the result of step (2)(i) by the first limit value.

24. The method of claim 20, wherein step (2) comprises:
(i) subtracting a first limit value for the engine from a first data value acquired in step (1);
(ii) dividing the result of step (2)(i) by the first limit value; and
(iii) multiplying the result of step (2)(ii) by a scaling value.
